(19) United States
(12) Patent Application Publication
(10) Pub. No.: US 2009/0089757 A1
(43) Pub. Date: Apr. 2, 2009

(54) Configurable Web Services System and a Method to Detect Defects in Software Applications

(75) Inventors: Sreeranga P. Rajan, Sunnyvale, CA (US); Oksana I. Tkachuk, Palo Alto, CA (US); Indradeep Ghosh, San Jose, CA (US); Mukul R. Prasad, San Jose, CA (US); Tadahiro Uehara, Yokohama (JP); Kazuki Munakata, Kawasaki (JP); Kenji Oki, Kawasaki (JP)

Correspondence Address: BAKER BOTTS L.L.P., 2001 ROSS AVENUE, SUITE 600, DALLAS, TX, 75201-2980, US

(73) Assignee: Fujitsu Limited, Kawasaki-shi (JP)

(21) Appl. No.: 11/865,610

(22) Filed: Oct. 1, 2007

(51) Int. Cl. G06F 9/44

(52) U.S. Cl. 717/124

(57) ABSTRACT

In accordance with a particular embodiment of the present invention, a method is offered that includes detecting one or more defects in a software application composed of heterogeneous languages using a configurable web services architecture. The detecting step further includes: capturing use cases associated with the software application and checking their validity; providing an automatic invocation of property monitors for model checking; and visualizing one or more defects in the software application for diagnosis. The detecting can further include transforming a heterogeneous software application into a homogeneous application. In more specific embodiments, the detecting further includes providing an automatic test generation for a presentation layer associated with the software application. The configuration associated with the software application can be a simple properties file. The detecting further includes simulating user behavior and generating drivers to test business logic from the use cases or scenarios.

### TECHNICAL FIELD OF THE INVENTION

This invention relates generally to the field of web services and, more specifically, to a configurable web services system and a method to detect defects in software applications.

### BACKGROUND OF THE INVENTION

Web applications are ubiquitous in today's processing world. Java is a popular choice for implementing the backbone [or significant portions] of many software applications, but typical web applications are heterogeneous systems integrating a variety of languages and technologies, including: HTML, JavaScript, PHP, Perl, and MySql.

Testing techniques are insufficient in many regards, including their inability to catch difficult corner-case bugs. This problem is more troublesome as the complexity of the software system increases. Thus, formal validation techniques are required, especially when validating complex software systems and/or when checking safety or security critical aspects of systems.

There is a large body of work on formal software validation technologies and even some recent work on applying some of them to Java-based systems. However, there is no end-to-end solution for large heterogeneous systems such as web applications. Point tools, whenever available, are too general to work well for web applications. Their usage and formalisms are too difficult to comprehend for the average system engineer and, further, their application is not sufficiently automated and too ad hoc to be easily repeatable: much less standardized.

Therefore, the ability to solve these significant validation problems in web services creates an interesting challenge. As with all such processing operations, of critical importance are issues relating to speed, accuracy, and automation.

### SUMMARY OF THE INVENTION

The present invention provides a method and a system for providing a configurable web services system and a method to detect defects in software applications that substantially eliminates or reduces at least some of the disadvantages and problems associated with previous methods and systems.

In accordance with a particular embodiment of the present invention, a method is offered that includes detecting one or more defects in a software application composed of heterogeneous languages using a configurable web services architecture. The detecting step further includes: capturing use cases associated with the software application and checking their validity; providing an automatic invocation of property monitors for model checking; and visualizing one or more defects in the software application for diagnosis.

The detecting can further include transforming a heterogeneous software application into a homogeneous application. In more specific embodiments, the detecting further includes providing an automatic test generation for a presentation layer associated with the software application. The configuration associated with the software application can be a simple properties file. The detecting further includes simulating user behavior and generating drivers to test business logic from the use cases or scenarios.

In still other embodiments, the detecting includes replacing a database by empty or user-supplied stubs. The detecting can further include verifying business logic for the software application.

Technical advantages of particular embodiments of the present invention include enabling rapid customization and increased automation for validation of large software code bases [based on the domain-specificity of the software application]. For example, the web application could be a financial application requiring security properties to be validated. In addition, the configuration will be customized to achieve maximum automation in performing such validation. The configuration can be specified using a properties file (e.g., XML).

The present invention can also offer an end-to-end solution for formally validating enterprise-strength web applications. Moreover, it offers a choice of an appropriate set of technologies well suited to the nature of such applications. It may further provide customization of the toolset to web applications to maximize efficacy of the toolset on this class of Java applications. For example, this could include the specific choice and composition of property templates and use of a string manipulation library in symbolic execution. It also offers flexibility in capturing requirements either in a simple specification language or using a visual formalism such as UML.

Other technical advantages will be readily apparent to one skilled in the art from the following figures, descriptions, and claims. Moreover, while specific advantages have been enumerated above, various embodiments may include all, some or none of the enumerated advantages.

### BRIEF DESCRIPTION OF THE DRAWINGS

For a more complete understanding of particular embodiments of the invention and their advantages, reference is now made to the following descriptions, taken in conjunction with the accompanying drawings, in which:

FIG. 1 is a simplified block diagram illustrating an example system that depicts how validation is typically executed;

FIG. 2 is a simplified block diagram illustrating a configurable web service architecture for validating software in accordance with one embodiment of the present invention;

FIG. 3 is simplified diagram illustrating a web application architecture for one embodiment of the present invention;

FIG. 4 is a simplified block diagram illustrating an example of how the SAVE architecture can operate;

FIG. 5 is a simplified block diagram illustrating some teachings associated with a method to categorize global system requirements or properties in accordance with one embodiment of the present invention;

FIG. 6 is a simplified diagram illustrating a process flow for one example scenario; and

FIG. 7 is a simplified diagram illustrating a flowchart for one example scenario associated with the present invention.

### DETAILED DESCRIPTION OF THE INVENTION

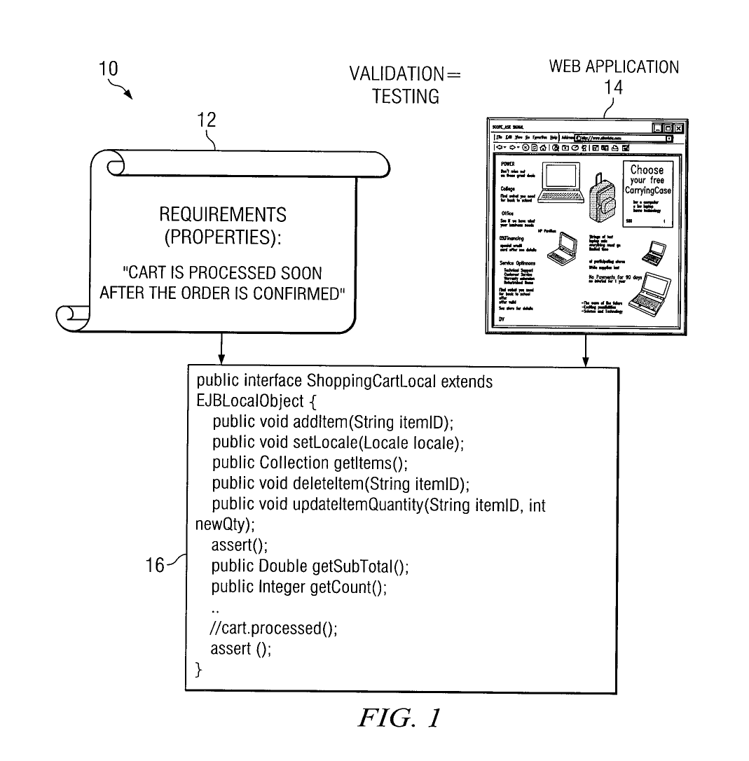

FIG. 1 is a simplified block diagram illustrating an example system 10 that depicts how validation is typically executed. FIG. 1 includes a requirements component 12, a web application 14, and a data segment 16 that relates to both of these items. Validation is typically done by manually inserting assertions within source code. Small modules are manually selected, but there is no way to handle the entire application source code. One problem with conventional testing is that it is manually intensive and, therefore, expensive, error-prone, and offers poor/unknown functional coverage.

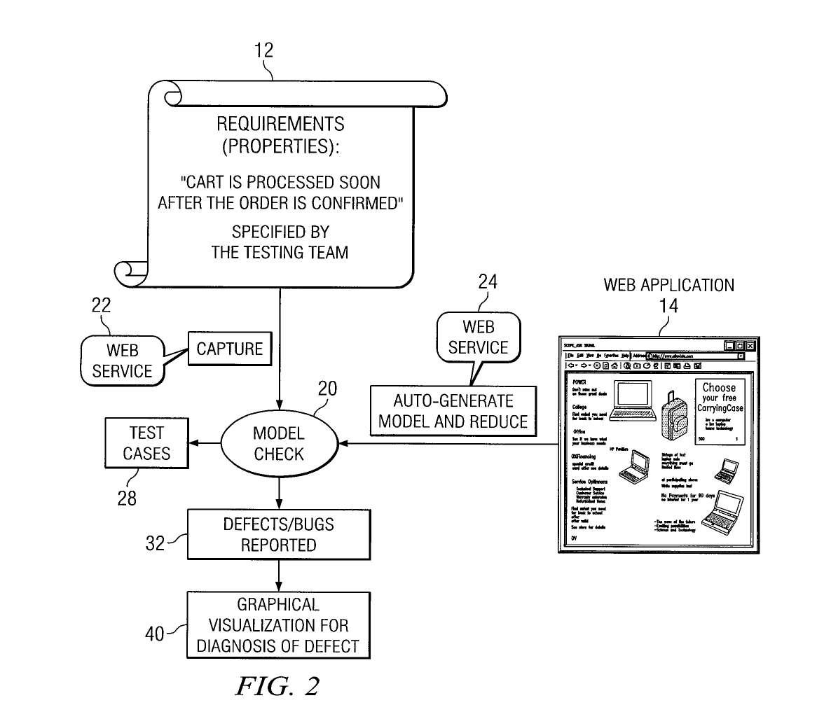

FIG. 2 is a simplified block diagram illustrating a configurable web service architecture for validating software in accordance with one embodiment of the present invention. FIG. 2 includes a model check 20, a web service 22, a web service 24, a test cases component 28, a defects/bugs reported component 32, and a graphical visualization for diagnosis of defect component 40. Collectively, these components of FIG. 2 cooperate to offer a new way for performing model checking for software applications. The architecture automates testing and provides high functional coverage for a given target system. Web application 14 can be a heterogeneous combination of program languages.

The embodiment of FIG. 2 can be viewed as a configurable web services architecture: referred to as SAVE (Software Applications Validation Environment). It includes interacting services for automatically checking requirements on Java-based web applications. Also provided is an associated methodology for deploying the constituent tools to efficiently validate real-world applications. The environment comprises a requirement capture service, environment/model generator service, automatic property template instantiation and matching service, a model checker, and a symbolic execution engine. A typical scenario of applying SAVE to a given web application is illustrated in FIG. 2.

The architecture presented in FIG. 2 (and in subsequent FIGURES) has a large scope covering defect detection in software applications composed of heterogeneous languages. The architecture can detect defects in software applications that may include the following interacting services: 1) capturing use cases/scenarios, and checking their validity; 2) environment generation to transform a heterogeneous software application into a stand-alone homogeneous application; 3) automatic invocation of property monitors for model checking; 4) visualization of defects for diagnosis; 5) automatic test generation for presentation layer; and 6) configuration can be just a simple properties (XML) file.

In essence, the present invention relates to top-level methodologies in software defect detection. A target architecture is usually published in white papers of products from companies and, therefore, it is easy to identify similarities with SAVE.

The objective [in the endeavors outlined herein] is to reduce failure costs by innovative software quality. Failures in this arena include: 1) application software flaws causing financial disasters; 2) embedded systems: automotive software defects cause stalling; 3) e-Commerce web sites hacked or go down. Of similar significance is the expense in fixing these issues. Rough estimates for the cost of fixing a bug in the field is approximately $30,000 vs. $5000 for fixing a bug during coding/development. Thus, the mission is to develop innovative techniques to intelligently evaluate software. Specifically, the goal is to identify defects during software development with 100% coverage, which is not achievable with conventional testing techniques.

Such an architecture has numerous advantages, including enabling rapid customization and increased automation for validation of large software code bases, based on the domain-specificity of the software application. For example, the web application could be a financial application requiring security properties to be validated. In addition, the configuration can be customized to achieve maximum automation in performing such validation. In one embodiment, the configuration can be specified using a properties file in XML.

The tendered system can also offer a viable end-to-end solution for formally validating enterprise-strength web applications. Moreover, it offers a choice of an appropriate set of technologies well suited to the nature of such applications. It may further provide customization of the toolset to web applications to maximize efficacy of the toolset on this class of Java applications. This could apply to the specific choice and composition of property templates, the use of a string manipulation library in symbolic execution, etc. There is flexibility in capturing requirements either in a simple specification language or using a visual formalism such as UML.

Inherently, the proposed system offers an emphasis on automation and a simple user-friendly interface to enhance usability of the toolset for the average system engineer. For example, the use of property templates transforms the often complicated and error prone task of specifying requirements, to a few clicks on a pull-down menu and minimal completion of some forms (form filling). There is a symbiotic interaction of various constituent tools to enhance the overall power of each step in the validation process. This could include static analysis based on symbolic execution used to enhance environment generation. This could also include property templates being used to automatically specify and verify more expressive properties with symbolic execution based model checking.

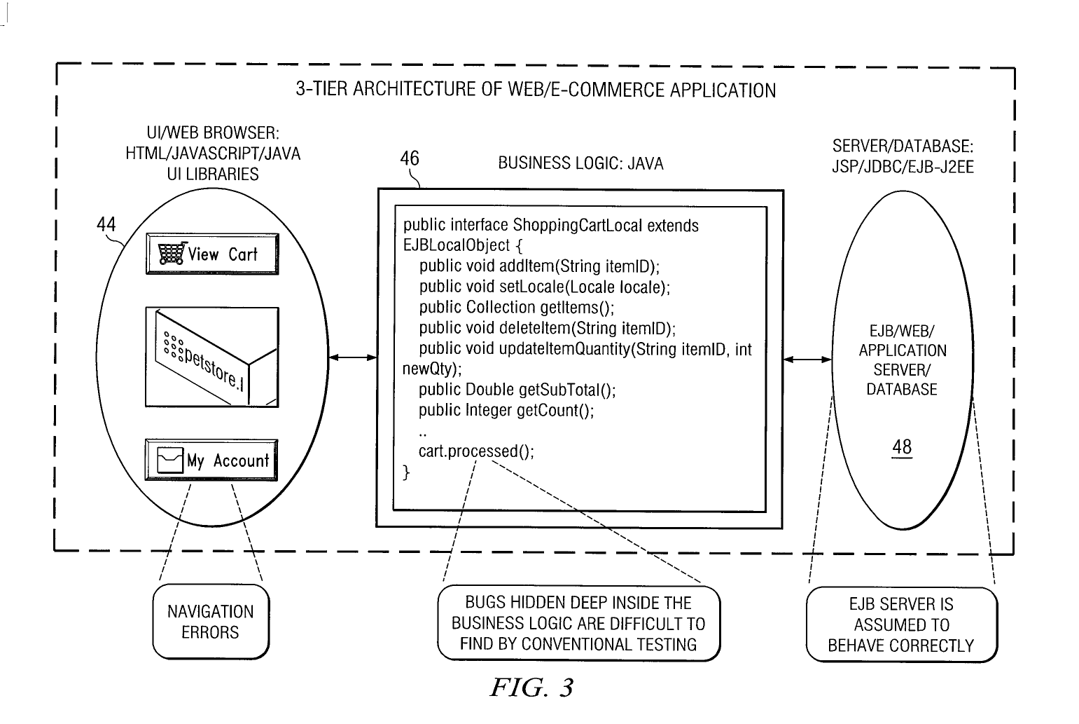

FIG. 3 illustrates a simplified block diagram illustrating a web application architecture. Specifically, FIG. 3 represents a 3-tier architecture of a web/e-Commerce application. FIG. 3 includes a UI/web browser 44, business logic 46 (which is Java in this instance), and a server/database 48. UI/web browser 44 includes navigation errors. Bugs hidden deep inside business logic 46 are difficult to find by conventional testing. In this scenario, the EJB server is assumed to behave correctly.

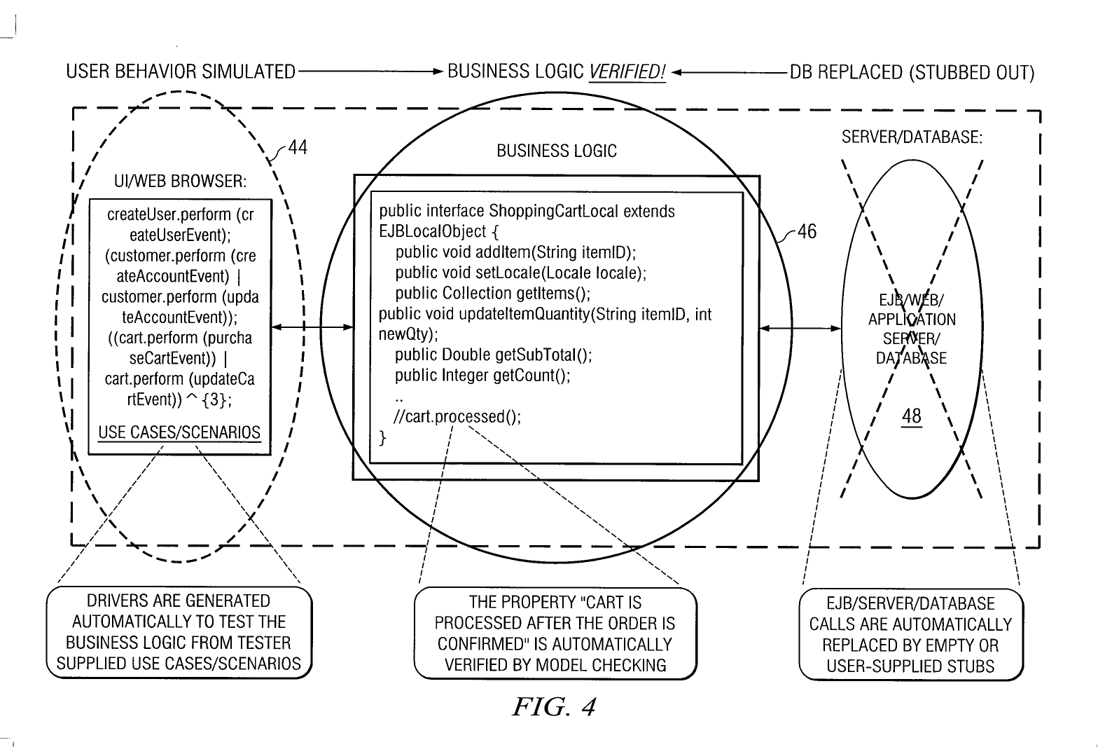

FIG. 4 is a simplified block diagram illustrating how the SAVE architecture can operate. User behavior is simulated initially. Drivers are generated automatically to test the business logic from tester supplied use cases/scenarios. Then, business logic is verified. The Property “Cart is processed after the Order is Confirmed” is automatically verified by model checking.

At a subsequent step, the database is replaced (stubbed out). In this case, the EJB/server/database calls are automatically replaced by empty or user-supplied stubs.

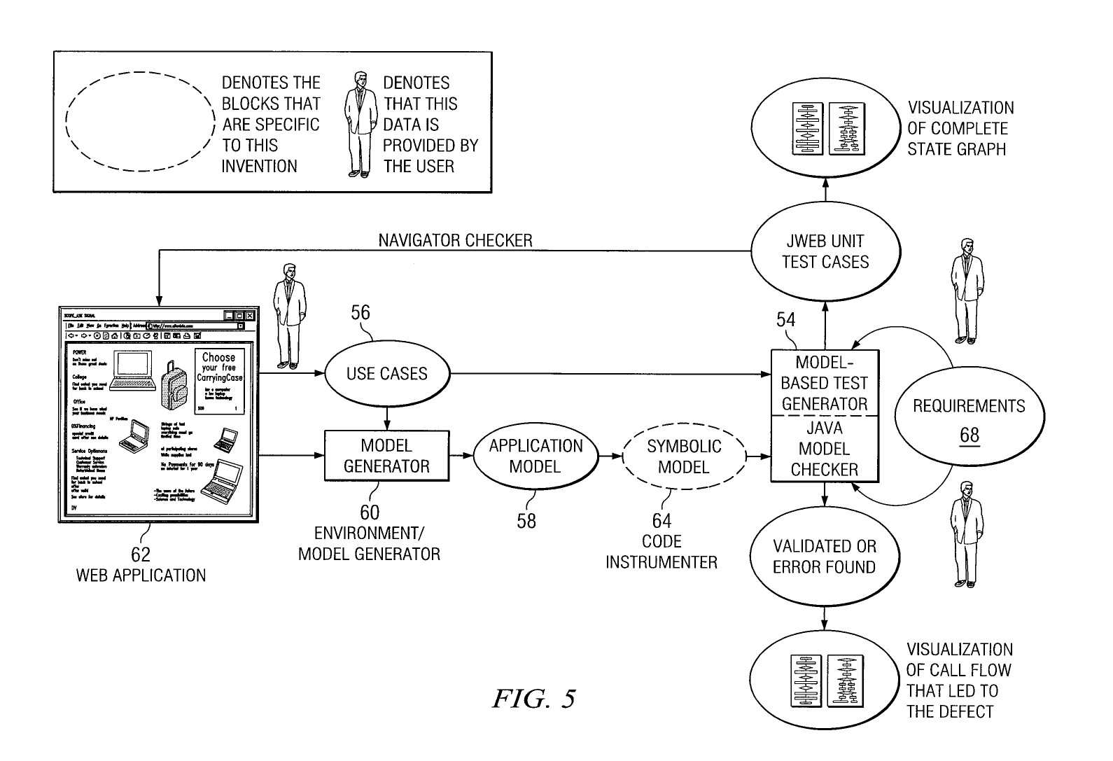

Before turning to FIG. 5, it is helpful to provide a simple case study that helps explain some of the significance of the present invention. A case study was executed for PetStore (13,000 lines). Three critical defects have been found with the PetStore web application available from Sun Microsystems Blueprints Web Site. PetStore is a benchmark web application developed in 2001 and has undergone five revisions since then. The 4th revision, released in 2006, was used for the testing. The latest release is an AJAX version of the 4th revision.

In terms of the requirements validated:
Shopping cart is processed on check out after order is confirmed.
   Validated by SAVE environment generation and model checking.
Total order price=Cart items' total price.
   Validated by SAVE environment generation and model checking.
When the order >$500, the status is pending.
   Validated by SAVE environment generation and symbolic execution.
Birds_Product_Page must be reached before Birds_Item_Page.
   Validated by SAVE model checking-based test generation.

In terms of the defects detected:
Password mismatch not checked.
   Security problem detected by SAVE environment generation and model checking.
Blank account profile.
   User account created with either a blank profile or some preexisting profile.
   Detected by automatic test case generation based on SAVE requirements model checking.
Crashes when reusing an account user name for creating a new user.
   Detected by SAVE model-checking based test generation.

The identification of these defects in this example reflects the importance of proper validation. Without a tool, such as that offered by the present invention, the PetStore model would continuously falter or fail each time the defect is encountered.

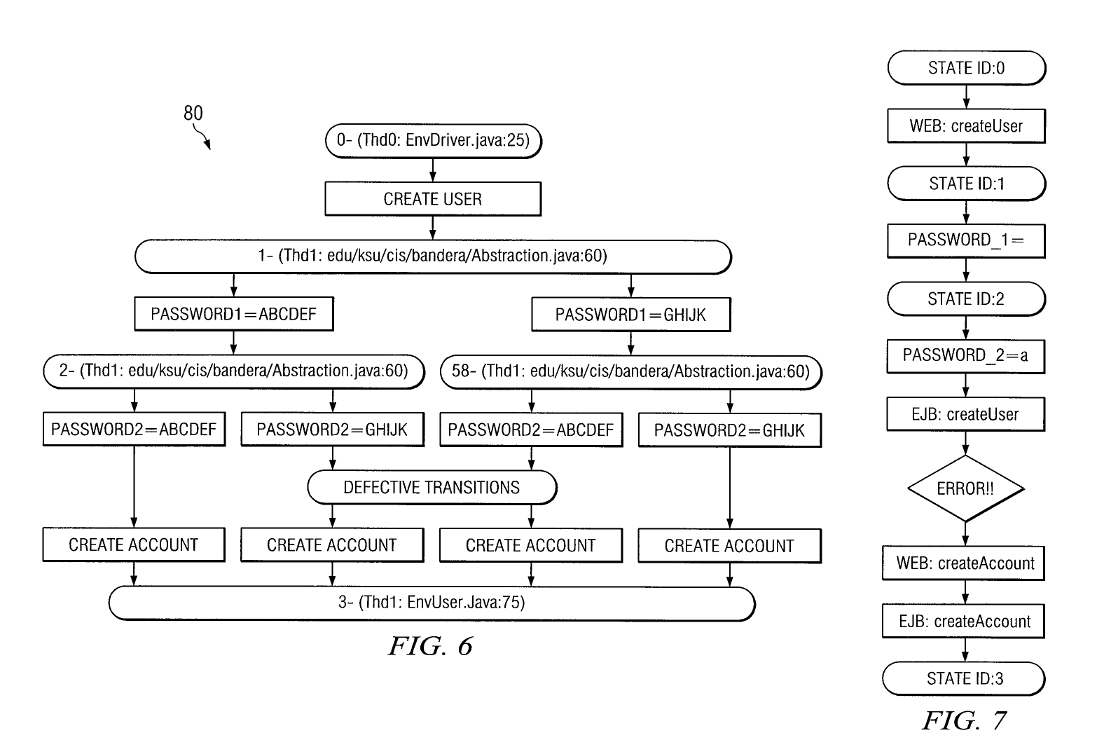

FIG. 6 is a simplified diagram illustrating a process flow for one example scenario involving a software application. FIG. 7 is a simplified diagram illustrating a related flowchart. FIG. 6 includes a defective transitions component 80 that is highlighted in the process flow. The flow includes account creation, password setup steps, and general procedural steps often encountered in a typical software environment. As a related matter, FIG. 7 illustrates the password and state ID segments in a flowchart: these items occurring while an account is being created.

FIG. 5 can be used to highlight some (but not all) teachings associated with a method to categorize global system requirements/properties, automate property specification, and to automatically invoke corresponding requirement checkers. FIG. 5 is a simplified block diagram illustrating an example model checker related to one aspect of the present invention. FIG. 5 includes a Java model checker/model-based test generator 54, a set of use cases 56, a web application 62, a model generator 60, an application model 58, and a requirement/property specification tool 68 (abbreviated as ‘Requirements’ in FIG. 5). FIG. 5 also includes some visualization components, as well as a ‘validated or error found’ element. FIG. 5 further includes a symbolic model [code instrumenter] 64, a navigation checker path, and a Jweb unit test cases component.

The global system aspect of the present invention can, first, classify properties/requirements into a small number of categories based on the domain of the software application (such as e-commerce, financial, etc.). This classification can be done a priori for each domain. It also scans the source code of the Java application and creates a set of interesting events that the user can choose from when specifying his requirements. A set of specific requirements/properties [that need to be satisfied] is then matched with the categories. After a successful match, monitors/property checkers are invoked corresponding to the instantiated property category.

Formal validation techniques for software are problematic. For example, point tools (e.g., model checkers) for (pure) Java are difficult to apply stand-alone; formalisms and are usage difficult to master for an average system engineer; and there is no customization for web applications.

Formal properties/requirements described in a mathematical language (called LTL [linear temporal logic]) are non-intuitive and complicated and, further, designers need an easier way to specify this (especially GUI-based systems). Furthermore, what is needed is a methodology to detect interesting “events” for an application. These events can then be used to populate properties. Thus, there is a need to increase the usability of a formal verification methodology for web applications.

In terms of property classification/templates, model checking requirements in JPF requires two steps: expressing the property precisely in a temporal logic (e.g. CTL, LTL); and coding a Java monitor implementing property that executes along with JPF and checks. Property templates automate these steps in the context of web applications. Here, the user chooses from a small list of templates, which are designed to capture most of the commonly checked requirements for web applications. For example, about fifty pages of requirement documents are reduced to about ten generalized templates.

The user then enters a few parameters into this template based on the specific application and property to be checked and, subsequently, invokes model checking in SAVE (e.g., to check the selected property: “The shopping cart is emptied after checkout in every shopping session.”). Steps may include: 1) choose the response property template in SAVE: Event b follows a; 2) form-fill the events “cartempty” and “checkout” corresponding to a and b respectively; and 3) invoke model checking in SAVE.

The advantages of property templates include the ease of specification and, furthermore, it is easy to match a natural language requirement to one among a small list of templates. In addition, there is no need to write a precise mathematical language property. The list of templates can serve as a guide in assembling the set of requirements to validate. There is also an ease of model checking.

In regards to automatic monitor generation, monitors corresponding to property templates are developed a priori. Using domain-specific automated static analysis, program objects/events (corresponding to the relations present in the property specification) are effectively found. A suitable property template is then instantiated with the program objects/events. The monitor corresponding to the template is invoked with appropriate instantiations. The software application to be validated is then run with the monitor watching the execution. Collectively, these actions achieve a viable approach for software validation.

It is critical to note that the components illustrated in FIGS. 1, 2, 3, 4, and 5 may be implemented as digital circuits, analog circuits, software, or any suitable combination of these elements. In addition, any of these illustrated components may include software and/or an algorithm to effectuate their features and/or applications as described herein. The software can execute code such that the functions outlined herein can be performed. Alternatively, such operations and techniques may be achieved by any suitable hardware, component, device, application specific integrated circuit (ASIC), additional software, field programmable gate array (FPGA), processor, erasable programmable ROM (EPROM), electrically erasable programmable ROM (EEPROM), or any other suitable object that is operable to facilitate such operations. Considerable flexibility is provided by the structure of these architectures in the context of this arrangement. Thus, it can be easily appreciated that such functions could be provided external to the outlined environment. In such cases, such a functionality could be readily embodied in a separate component, device, or module.

While the present invention has been described in detail with specific components being identified, various changes and modifications may be suggested to one skilled in the art and, further, it is intended that the present invention encompass any such changes and modifications as clearly falling within the scope of the appended claims.

Note also that, with respect to specific process flows disclosed, any steps discussed within the flows may be modified, augmented, or omitted without departing from the scope of the invention. Additionally, steps may be performed in any suitable order, or concurrently, without departing from the scope of the invention.

Numerous other changes, substitutions, variations, alterations, and modifications may be ascertained to one skilled in the art and it is intended that the present invention encompass all such changes, substitutions, variations, alterations, and modifications as falling within the scope of the appended claims.

What is claimed is:

1. A method, comprising:
detecting one or more defects in a software application composed of heterogeneous languages using a configurable web services architecture, wherein the detecting step further includes:
capturing use cases associated with the software application and checking their validity;
providing an automatic invocation of property monitors for model checking; and
visualizing one or more defects in the software application for diagnosis.

2. The method of claim 1, wherein the detecting further includes transforming a heterogeneous software application into a homogeneous application.

3. The method of claim 1, wherein the detecting further includes providing an automatic test generation for a presentation layer associated with the software application.

4. The method of claim 1, wherein configuration associated with the software application is a simple properties file.

5. The method of claim 1, wherein the detecting further includes simulating user behavior.

6. The method of claim 1, wherein the detecting further includes generating drivers to test business logic from the use cases or scenarios.

7. The method of claim 1, wherein the detecting further includes replacing a database by empty or user-supplied stubs.

8. The method of claim 1, wherein the detecting further includes verifying business logic for the software application.

9. A method, comprising:
classifying properties or requirements into a small number of categories based on a domain of a software application;
scanning source code of a Java application;
creating a set of events that an end user can choose from when specifying the properties or requirements;
matching a selected set of requirements or properties that need to be satisfied with one or more categories; and
invoking monitors or property checkers corresponding to an instantiated property category after a successful match of the category to the monitors or the property checkers.

10. The method of claim 9, wherein the classification is done a priori for each domain of the software application.

11. Logic embedded in a computer medium and operable to:
detect one or more defects in a software application composed of heterogeneous languages using a configurable web services architecture, wherein the detect operation further includes:
capturing use cases associated with the software application and checking their validity;
providing an automatic invocation of property monitors for model checking; and
visualizing one or more defects in the software application for diagnosis.

12. The logic of claim 11, wherein the detect operation further includes transforming a heterogeneous software application into a homogeneous application.

13. The logic of claim 11, wherein the detect operation further includes providing an automatic test generation for a presentation layer associated with the software application.

14. The logic of claim 11, wherein configuration associated with the software application is a simple properties file.

15. The logic of claim 11, wherein the detect operation further includes simulating user behavior.

16. The logic of claim 11, wherein the detect operation further includes generating drivers to test business logic from the use cases or scenarios.

17. The logic of claim 11, wherein the detect operation further includes replacing a database by empty or user-supplied stubs.

18. The logic of claim 11, wherein the detect operation further includes verifying business logic for the software application.

19. The logic of claim 11, wherein drivers are generated automatically to test business logic from tester supplied use cases, the business logic being verified, whereby a property is automatically verified by model checking.

20. The logic of claim 11, wherein the software application relates to an e-Commerce application.
